(19) United States
(12) Patent Application Publication
(10) Pub. No.: US 2012/0178620 A1
(43) Pub. Date: Jul. 12, 2012

(54) CARBOXYETHYL CELLULOSE FIBERS, THEIR USE IN WOUND DRESSINGS AND HYGIENE ITEMS AND METHOD FOR PRODUCING THE SAME

(75) Inventors: Rastislav Krajcik, Vocklabruck (AT); Shayda Rahbaran, Vocklabruck (AT)

(73) Assignee: LENZING AG, Lenzing (AT)

(21) Appl. No.: 13/392,281

(22) PCT Filed: Jul. 27, 2010
(86) PCT No.: PCT/AT2010/000265

§ 371 Date: Mar. 26, 2012

(30) Foreign Application Priority Data
Aug. 28, 2009 (AT) A 1357/2009

(51) Int. Cl. B01J 20/26; C08B 11/20

(52) U.S. Cl. 502/402; 525/54.3

(57) ABSTRACT

The present invention relates to carboxyethyl cellulose fibers, to a method for producing the same and their use for wound treatment, especially in wound dressings, in other products for medical applications such as swabs, bandages and the like, and in hygiene items, and in all these applications, particularly for producing a surface to be in contact with the body. The products produced from the fibers according to the invention do not stick to the wounds or to the skin despite being extremely absorbent and have such good cohesion in the swollen state that especially the wound dressings produced therefrom can be peeled off from the wound in one piece without injuring the same.

### BACKGROUND OF THE INVENTION

### Prior Art

Generally, cellulose fibers are suitable for use in the treatment of wounds and also in the hygiene sector because cellulose is very compatible with skin and wounds. Apart from natural cellulose fibers such as cotton, synthetic cellulose fibers such as viscose, lyocell, cupro or polynosic are commercially available and known in these applications. According to the BISFA definition, Lyocell is a fiber spun from an organic solvent. Possible methods of producing it are described, inter alia, in U.S. Pat. No. 4,246,221 and U.S. Pat. No. 4,196,282. Processes for producing the other cellulosic synthetic fibers have been known much longer.

The use of absorbent cellulosic materials in medical applications, for example in wound dressings has long been known, inter alia, from U.S. Pat. No. 4,203,435.

AT 363578 describes the production of absorbent cellulose-based fibers by spinning of carboxymethyl cellulose and other cellulose derivatives in viscose.

Also, chemically modified polysaccharides find use as absorbent components of wound dressings and padding, for example according to EP 0092999 in the form of water-dispersible hydrocolloids made from carboxymethyl cellulose or according to EP 0680344 in the form of cellulose fibers which have been carboxymethylated following the extrusion from an NMMO solution.

Wound dressings which contain carboxymethyl cellulose fibers, however, have the disadvantage that the derivatization of the fibers is performed using monochloroacetic acid, leading to a reduction in strength of the fibers and thus later to insufficient cohesion of the gel layer swollen due to liquid absorption.

Methods for producing carboxyethyl cellulose have also already been described in the prior art. For example, US20060137838 proposes the production of carboxyethyl cellulose from wood pulp in the same manner as from carboxymethyl cellulose using the appropriate chloroalkyl acids as reagent. This method is well suited for producing carboxymethyl cellulose. However, the analogous preparation of carboxyethyl cellulose fibers in this way is economical not possible. By reworking these procedures, no economically relevant yield of carboxyethyl cellulose fibers could be obtained. The fibers did not have any significantly higher water retention capacity compared to underivatized control fibers. It is therefore likely that the relevant information to carboxyethyl production is merely theoretical in nature and has not been checked technically.

U.S. Pat. No. 5,667,637 discloses the production of carboxyethyl cellulose, starting from wood pulp with acrylamide for paper applications.

In the literature, the use of carboxyethyl cellulose is often suggested for wound dressings, but always only in lists of various theoretically possible alternatives to carboxymethylcellulose. Practice-relevant properties of such carboxyethyl celluloses or concrete examples are not listed. Also, information on the strength of such fibers is nowhere to be found.

### SUMMARY OF THE INVENTION

In view of the prior art, the object was to provide an alternative cellulose-based material for the absorption of fluids and in particular body fluids, for example for use in wound dressings and other products for medical applications or hygiene applications, and particularly for producing a surface to be in contact with the body and a method for producing it. In the swollen state, this material must have greater cohesion than previously known materials, which allows, for example, that a wound dressing produced therefrom can be peeled off from the wound in one piece.

This problem could be solved by the first provision of water insoluble carboxyethyl cellulose fibers that have a strength in the conditioned state of at least 15 cN/tex, and have a water retention capacity of at least 400% while maintaining their fibrous form.

### DETAILED DESCRIPTION OF THE INVENTION

Preferably, the carboxyethyl cellulose fibers have a water retention capacity of at least 600%, particularly preferably at least 800%.

The strength of these carboxyethyl cellulose fibers in the conditioned state is preferably at least 20 cN/tex. In principle, strengths up to those of the underivatized fibers are possible to obtain, i.e., up to about 40 cN/tex.

It has surprisingly been found that carboxyethyl cellulose fibers suitable for these applications have sufficient mechanical properties if they were prepared by derivatization of lyocell, viscose or modal fibers. These mechanical properties allow, for example, that a wound dressing produced from the fibers according to the invention after contact with water or wound fluid forms a transparent gel, while it still retains a high strength, which allows for it to be peeled off from a wound without residues. Also, for hygiene items it is of great importance that fibers used have sufficient mechanical cohesion after the absorption of body fluids and the associated swelling with gel formation.

Since, as already stated above, the processes for producing carboxyethyl cellulose fibers proposed in the prior art are practically unsuccessful, initially there was a need to develop a suitable production method.

The present invention therefore also provides a process for producing these water-insoluble carboxyethyl cellulose fibers, wherein cellulosic synthetic fibers are reacted with acrylamide in strong alkali.

Basically, the titer of the fibers used may be selected arbitrarily and is determined by the application. For many applications a not too rough structure of the body-facing surface may be preferred. Preferred is therefore a single fiber titer of 0.5 dtex-6.0 dtex, more preferably 1.4 to 3.3 dtex. Fibers having a single fiber titer of less than 0.5 dtex are practically not relevant.

The cellulosic synthetic fibers can be used in the form of cut individual fibers—also referred to as staple fibers—, filaments, continuous filament tow, nonwoven fabrics, woven fabrics, knitted fabrics and/or other textile fabrics. As the cellulosic synthetic fibers, preferably lyocell, viscose or modal fibers are used.

Preferred alkali is sodium hydroxide. However, the use of any strong alkali is possible. The alkali concentration should be 2-10%, preferably, however, 4-6%. Surprisingly, it has been found that the aqueous solution may contain 1 to 75% of ethanol, preferably 15 to 30% of ethanol.

The amount of acrylamide used is closely related to the desired degree of substitution. Per anhydroglucose unit 2-10 molecules of acrylamide can be used in the reaction. Preferably, 6-10 molecules of acrylamide are used per anhydroglucose and particularly preferably 7 or 8 molecules of acrylamide. The reaction takes 30 to 120 min, preferably 50-70 min, at a temperature of 30-90° C., preferably at 40-60° C. Additionally, after this reaction, the reaction temperature can be increased up to 90° C. and treatment may continue for additional 30 to 120 min. Preferred is an increase of 10-40° C. Most preferably, the temperature is increased to 60-80° C., and the reaction is continued for additional 50-70 min. The values of water retention capacity in 0.9% NaCl solution achieved in this manner reach 200-600%.

These values are surprisingly increased significantly by a post-treatment of the fibers with a 3-10% alkali, preferably with a 4-6% alkali. Preferably, sodium hydroxide is used as alkali, but in principle, any solution of an alkali metal hydroxide is suitable. The aqueous alkali solution may contain 1 to 75% ethanol, preferably 30 to 70%. This post-treatment takes 30-120 min, preferably 50-70 min at a temperature of 30-90° C., preferably at 60-80° C.

If no ethanol is added during the reaction and/or during the post-treatment step, the final product has a much lower water retention capacity than if the procedure is performed in accordance with the invention.

The CEC fibers are washed and dried after the post-treatment. For washing, a mixture of ethanol, water and a weak acid is used. Preferred is a solution of 20-80% of ethanol, 19-79% of water and 1-10% of a weak acid, preferably 40-70% of ethanol, 29-59% of water and 1-10% of a weak acid. As a weak acid, preferably citric or acetic acid is used. Finally, the fibers are washed with a solution of a fatty acid ester in ethanol, preferably polyoxyethylene sorbitan fatty acid ester, for example, 1% Tween 20, in ethanol, and then dried.

The final fibers have a neutral to slightly acidic pH value (pH 5.5 to 7.5) and a water retention capacity of 400% up to over 1200% in 0.9% saline.

The fibers thus produced can be used in particular for producing products for absorbing liquids and body fluids, for example for use in products for medical applications or hygiene applications. These fibers can also be used for products for maintaining of moisture of wounds, e.g. with saline. The use takes place in the contact area, which faces the body, i.e., which is in contact with the body. In the case of wound dressings, band aids, bandages, swabs and the like, it is usually the wound to be treated or any other open area of the body. In the case of hygiene items such as baby diapers and incontinence products and feminine hygiene products, it is a skin surface or body part appropriate for the intended application. Only in hygiene items, frequently a layer of PP or PES, a so-called top sheet, is inserted between the skin and the fiber layer. Surprisingly, it has been found that it is critical for a successful application that the carboxyethyl cellulose fibers have a strength in the conditioned state of at least 15 cN/tex, preferably at least 20 cN/tex and a water retention capacity of at least 400%. According to the current state of the art for this purpose only the above described method according to the invention is suitable.

Preferably, the carboxyethyl cellulose fibers can be used in the form of cut individual fibers—also referred to as staple fibers—, filaments, continuous filament tow, nonwoven fabrics, woven fabrics, knitted fabrics and/or other textile fabrics.

For use in wound dressings the carboxyethyl cellulose fiber itself or another part of the wound dressing may be provided with additives of Ag, Cu and Zn compounds, chitosan and other antimicrobial components.

### EXAMPLES

The invention will now be explained using examples. These are understood to be possible embodiments of the invention. By no means is the invention limited to the extent of these examples.

Determination of water retention capacity (according to standard DIN 53814):

The water retention capacity as a measure of the absorbency of the fibers according to the invention is defined as the liquid absorption by swelling of a certain amount of fiber as a percentage of the dry weight and is determined as follows: In a centrifuge vessel, 0.5 g of fibers are mixed with sufficient 0.9% saline until the fluid leaks from the bottom. Thereafter, again saline is added and allowed to stand for 2 hours. The centrifuge vessels are then spun at 3400 rpm (=9500 m/s²) for 20 min and then the fibers are weighed in weighing bottles. Then, the fibers are dried at 105° C. for 16-18 hours, and after cooling, they are weighed again (according. The difference between the two masses is multiplied by 100 and divided by the dry weight yields the water retention capacity as a percentage. The CEC fibers reach values of water retention capacity of at least 400%, preferably at least 600% and more preferably at least 800% in 0.9% saline.

### Example 1

Lyocell fibers having a single fiber titer of 1.4 dtex are added into 5.6% aqueous NaOH solution. The solution further contains 25% ethanol and 240 g/l acrylamide. The mixture is heated to 50° C. and is allowed to react for 60 min. Thereafter, the temperature in increased to 70° C. and is allowed to react for additional 60 min. After the reaction, the fibers are pressed with a pressing roller to a moisture content of 100%. The pressed fibers are treated with 4% aqueous NaOH solution containing 50% ethanol, at 70° C. for 60 min. Following this second treatment, the fibers are again pressed and washed with a solution of 55% ethanol, 42% water and 3% citric acid. Washing once with 1% Tween® 20 in ethanol follows as the final treatment step. The fibers are then dried. The resulting fibers have a water retention capacity of 900% in 0.9% NaCl solution and conditioned a strength of 22 cN/tex.

### Example 2

### Comparative Example

To show clearly the impact of the addition of ethanol during the reaction and the post-treatment step, the ethanol addition was omitted in the following experiment. Everything else was repeated as in Example 1 without change.

Lyocell fibers having a single fiber titer of 1.4 dtex are added into 5.6% aqueous NaOH solution. The solution further contains furthermore and 240 g/l acrylamide. The mixture is heated to 50° C. and allowed to react for 60 min. Thereafter, the temperature in increased to 70° C. and allowed to react for additional 60 min. After the reaction, the fibers are pressed with a pressing roller to a moisture content of 100%. The pressed fibers are treated with 4% aqueous NaOH solution, at 70° C. for 60 min. Following this second treatment, the fibers are again pressed and washed with a solution of 55% ethanol, 42% water and 3% citric acid. As the final treatment step, washing once with 1% Tween® 20 in ethanol follows. The resulting fibers have a water retention capacity of 300% in 0.9% NaCl solution. Since the fibers thus obtained were always stuck to each other, the single fiber strength could not be determined.

1. Water-insoluble carboxyethyl cellulose fibers for absorption of liquids wherein said fibers have a strength in the conditioned state of at least 15 cN/tex and while maintaining their fiber form having a water retention capacity of at least 400%.

2. The carboxyethyl cellulose fibers according to claim 1, wherein the carboxyethyl cellulose fibers have a water retention capacity of preferably at least 600%.

3. The carboxyethyl cellulose fibers according to claim 1, wherein the carboxyethyl cellulose fibers have a strength in the conditioned state of at least 20 cN/tex.

4. The carboxyethyl cellulose fibers according to claim 1, 2 or 3 wherein said fibers are produced by derivatization of a fiber selected from the group consisting of lyocell, viscose and modal fibers.

5. A process for producing water-insoluble carboxyethyl cellulose fibers according to claim 1, comprising reacting cellulosic synthetic fibers with acrylamide in a strong alkali.

6. The method according to claim 5, further comprising post-treating the fibers with alkali after the reacting with acrylamide in the strong alkali.

7. The method according to claim 5 or 6, wherein the reacting and/or the post-treating occurs in a reaction solution and the reaction solution contains 1 to 75 weight-% of ethanol at least in one step.

8. The method according to claim 5 or 6, further comprising washing the fibers in a subsequent washing step with a mixture comprising ethanol, water and a weak acid.

9. The method according to claim 5, wherein the cellulosic synthetic fibers are in the form of fibers selected from the group consisting of individual fibers, continuous filament tow, nonwoven fabrics, textile fabrics and finished textiles.

10. The method according to claims 5 or 6, wherein the cellulosic synthetic fibers are selected from the group consisting of lyocell, viscose and modal fibers.

11. An absorbent product comprising water-insoluble carboxyethyl cellulose fibers wherein the carboxyethyl cellulose fibers have a strength in the conditioned state of at least 15 cN/tex and a water retention capacity of at least 400%.

12. The absorbent product according to claim 11, wherein the carboxyethyl cellulose fibers are selected from the group consisting of cut single fibers, filaments, continuous filament tow, nonwoven fabrics, woven fabrics, knitted fabrics and other textile fabrics.

13. The absorbent product according to claim 11, wherein the carboxyethyl cellulose fibers are produced according to the method of claim 5 or 6.

14. The absorbent product according to claim 11, wherein the product has a surface that is intended to be used in contact with the body.

15. The carboxyethyl cellulose fibers according to claim 1, wherein the liquids are body fluids.

16. The carboxyethyl cellulose fibers according to claim 1, wherein the fibers are included in wound dressings and other products for medical applications or hygiene applications.

17. The carboxyethyl cellulose fibers according to claim 16, wherein fibers produce a surface to be in contact with the body.

18. The carboxyethyl cellulose fibers according to claim 2, wherein the carboxyethyl cellulose fibers have a water retention capacity of preferably at least 800%.
